(19) United States
(12) Patent Application Publication
(10) Pub. No.: US 2017/0247577 A1
(43) Pub. Date: Aug. 31, 2017

(54) Repositionable Adhesive

(71) Applicant: Zephyros, Inc., Romeo, MI (US)

(72) Inventors: George Anthony Buchan, Northants (GB); Christy Stine, Royal Oak, MI (US); Kenneth A. Mazich, Birmingham, MI (US)

(21) Appl. No.: 15/509,706

(22) PCT Filed: Oct. 2, 2015
(86) PCT No.: PCT/US2015/053634

§ 371 Date: Mar. 8, 2017

Related U.S. Application Data
(60) Provisional application No. 62/058,788, filed on Oct. 2, 2014.
(60) Provisional application No. 62/201,317, filed on Aug. 5, 2015.

(51) Int. Cl. C09J 7/02; C09J 133/08; B29C 65/48; C09J 5/00

(52) U.S. Cl. CPC C09J 7/0217; C09J 5/00; C09J 133/08; C09J 7/0264; C09J 7/026; B29C 65/483; C09J 2433/00

(57) ABSTRACT

A method for using an adhesive comprising applying the adhesive to a substrate in a first position, adhering the adhesive to the substrate by applying pressure to the adhesive, optionally removing the adhesive from the substrate and re-applying the adhesive to the substrate in a second position and curing the adhesive at room temperature. The application also claims a tape material comprising: a substrate; an adhesive impregnated within the substrate, the adhesive comprising: i. one or more acrylates; ii. optionally one or more impact modifiers; iii. one or more elastomers; and iv. one or more initiators.

### FIELD OF THE INVENTION

The present teachings relate generally to repositionable adhesives. More specifically, the present teachings relate to adhesives utilized for repositionable structural and elastic tape and film adhesives.

### BACKGROUND OF THE INVENTION

A wide variety of industries (including transportation, construction, signage and many others) often utilize adhesives that are formulated to cure upon exposure to specific temperatures or other stimulus. However, many such adhesives do not allow for repositioning. Typically, paste materials are used for assembly processes where repositioning ability is desired. However, the paste materials often present handling challenges in that precise application of the paste to a part is not always easily controlled. In addition, many paste adhesives, due to their very nature, allow for repositioning via the sliding of the substrates over the liquid/paste adhesive material. However, application of such materials is complex and requires pumps, mixers, nozzles, and other application devices. As such, there is an ever present risk of wash and/or squeeze out when the assembled parts are exposed to cleaning cycles or production line movement prior to curing. Lastly, structural adhesive materials (as are commonly desired in transportation vehicle manufacture) are not available in paste form but are rather formed as tapes. There is generally no opportunity to modify the location of a part that utilizes such structural tapes as the tape adheres immediately (e.g., there is little or no delay between contact with a surface and permanent adherence).

Some tape sealants exist today that do allow for peel off and repositioning (for example butyl-based tape sealants). However, these materials have very poor creep resistance and mechanical properties.

It would therefore be desirable to provide a repositionable structural and/or elastic tape and/or film adhesive material that is formulated so that the adhesive allows for repositioning during the assembly process. It would further be desirable that the adhesive eliminate the need for expensive pumping systems compared to current paste adhesives and also eliminate the need for expensive static mixers commonly utilized with current paste adhesives. It would also be desirable to have a repositionable tape or film that will fully cure, and provide one or more of high strength (structural adhesion) or high elasticity with good creep resistance (elastic adhesives).

### SUMMARY OF THE INVENTION

The present teachings meet some or all of the above needs by providing for a method comprising applying an adhesive to a surface in a first position; adhering the adhesive on the surface by applying pressure to the adhesive; optionally repositioning the adhesive into a second position; curing the adhesive at room temperature.

The method may include forming the adhesive to form a tape. The method may include die-cutting, extruding, injection molding, calendaring, and/or hand shaping, the adhesive. The method may include forming the adhesive to form a composite material comprising a scrim, non-woven web, woven web, or any combination thereof. The method may include forming the adhesive as a handling film. The adhesive may be activated by applying an agent on the one or more surfaces, whereby the activating includes chemical activation, rheological activation, or both. The adhesive may be activated by applying an agent directly onto the adhesive, whereby the activating includes chemical activation, rheological activation, or both. The adhesive may comprise an encapsulated agent that activates curing, polymerization, or stiffening with pressure. The adhesive may cure upon exposure to a predetermined moisture level. The adhesive may be embedded with one or more conductive elements. Activation may occur by passing current through the one or more conductive elements. The adhesive may comprise ferromagnetic particles. The adhesive may be impregnated in a substrate. The substrate may comprise glass, carbon, thermoplastics, natural fibers, or combinations thereof. Upon application of the substrate and adhesive to the surface, a liquid layer of adhesive may form in between the surface and an outer layer of the adhesive. The adhesive may be tacky prior to cure. The adhesive may be a polymeric adhesive. The adhesive may comprise an acrylate.

The teachings herein further provide for a tape material comprising a substrate and an adhesive impregnated within the substrate, the adhesive comprising one or more acrylates, optionally one or more impact modifiers, one or more elastomers, and one or more initiators. The impact modifier may be a core shell polymer. The substrate may comprise glass, carbon, thermoplastics, natural fibers, or combinations thereof. The adhesive may be free of any isocyanates. The tape can be repositioned after locating the tape onto a surface. At least one of the one or more initiators may be encapsulated. The encapsulated initiator may be arranged such that when a force is applied to the tape material, the force ruptures the encapsulated one or more initiators thereby causing activation of the tape. The tape material may be packaged to prevent premature rupture of the encapsulated one or more initiators. The tape material may include a scrim layer. The tape material may include a scrim layer wherein at least one of the one or more initiators is impregnated within the scrim. The impregnated scrim may be arranged so that when a force is applied to the tape during use, the force ruptures the scrim thereby causing release of the at least one of the one or more initiators thereby causing activation of the tape. At least one of the one or more initiators may be activated to cause substantial but not complete curing prior to use of the tape so that at least an exterior surface layer of the tape remains substantially uncured and able to adhere to a surface. At least one of the one or more initiators may be activated to cause at least partial cure prior to use of the tape. At least one of the one or more initiators may be activated to cause complete curing after use of the tape. An initiator may be applied to the tape material after use of the tape to cause substantially complete curing. The tape material may be contacted with a material prior to packaging the tape to substantially prevent undesired premature curing prior to use of the tape. The tape material may be contacted with a monomer prior to packaging the tape to substantially prevent undesired premature curing prior to use of the tape. The tape material may include a high molecular weight polymer. The tape material may include a high molecular weight polymer having active acrylic bonds that co-polymerize with a monomer throughout the tape upon activation.

The structural and elastic tape and film adhesives described herein provide wide ranging mechanical properties from stiff to highly flexible materials, excellent adhesion to a wide range of surfaces and robust durability behavior. The materials described herein simplify the installation of adhesive tapes and films by elimination of pumpable paste materials commonly used for adhesion application. Further, unlike typical tapes or films, the current materials allow for the adhesive tape to be repositioned for ideal location on a surface.

### DETAILED DESCRIPTION

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

This application claims the benefit of the filing dates of U.S. Provisional Application No. 62/058,788, filed Oct. 2, 2014, and 62/201,317, Filed Aug. 5, 2015, the contents of these applications being hereby incorporated by reference herein for all purposes.

In general, the teachings herein provide a repositionable structural and/or elastic tape and/or film adhesive material that initially adheres to a surface with the application of pressure but can thereafter be repositioned until the adhesive is cured. Typically the adhesive is a room-temperature cure adhesive, but the adhesive may alternatively be cured by exposure to some other stimulus (e.g., UV cure, induction cure, etc.). The adhesive may be formulated to form a thin liquid layer on a surface to which the adhesive is applied. This liquid layer would allow the adhesive (and any substrate associated therewith to form a tape) to slide on the surface if needed, thereby allowing for parts to be reconfigured or adjusted to precisely the correct position. The adhesive may then cure rapidly and completely at room temperature, to provide more robust adhesion to a surface.

The adhesive may be formed as a film and/or located on and/or formed within a substrate material to form a tape. The substrate may be any material capable of maintaining the adhesive thereon or within. The substrate may be specifically selected so that the resulting tape maintains a tacky surface. The substrate may be a material that allows for significant flexibility of the resulting tape. The substrate may provide a predetermined amount of rigidity to the resulting tape. Examples of materials that may be suitable for forming the tape materials described herein include glass, carbon, thermoplastics, natural fibers, or combinations thereof. The adhesive may be formed into a variety of lengths, widths and thicknesses. If formed as a film, the adhesive may be shaped as a planar sheet. The film may also be cut into any desired shape. The film may be cut to match the shape of the surface receiving the adhesive, or the shape of a part upon which the adhesive will be located. The adhesive may also be formed into a planar sheet and then cut into strips to form a tape. The adhesive may be cut before being located onto/into a substrate. The adhesive may be cut after being located onto/into a substrate. The thickness of the adhesive may be at least about 500 microns or more, 1000 microns or more, 1500 microns or more, 2000 microns or more, or even 4000 microns or more. The thickness of the adhesive may be less than 5000 microns, less than 3000 micron, less than 1000 microns or even less than 500 microns. In the event that the adhesive is located onto or into a substrate, it is possible that the thickness of the adhesive may be less than the thickness of the substrate. The thickness of the adhesive may be 20% less, 50% less or even 80% less than the thickness of the substrate. It is also possible that the thickness of the adhesive may be greater than the thickness of the substrate. The thickness of the adhesive may be 5% greater, 20% greater, or even 50% greater than the thickness of the substrate.

At least one of the one or more initiators for initiating cure of the adhesive may be encapsulated. The encapsulated initiator may be arranged such that when a force is applied to the tape material, the force ruptures the encapsulated one or more initiators thereby causing activation of the tape. The tape material may also be packaged to prevent premature rupture of the encapsulated one or more initiators. As an alternative to encapsulation, the tape material may include a scrim layer with one or more initiators impregnated within the scrim. The impregnated scrim may be arranged so that when a force is applied to the tape during use, the force ruptures the scrim thereby causing release of the one or more initiators thereby causing activation of the tape.

The tape material may be contacted with a material prior to packaging the tape to substantially prevent undesired premature curing prior to use of the tape. The tape material may be contacted with a monomer prior to packaging the tape to substantially prevent undesired premature curing prior to use of the tape. The tape material may include a high molecular weight polymer. The tape material may include a high molecular weight polymer having active acrylic bonds that co-polymerize with a monomer throughout the tape upon activation.

The tape or film may have a tacky surface prior to initiation. Upon use of the tape or film (e.g., initiation), the adhesive may generate a liquid layer. The liquid layer may be formed as a result of surface activation from the surface that contacts the tape. Following initiation and generation of the liquid layer, the adhesive may cure (which may be as a result of room temperature cure).

The adhesive may be structural in nature. Alternatively, the adhesive may be an elastic adhesive material. Accordingly, the resulting tape may be a structural tape or may be a sealing tape. Other types of repositionable tape materials are also envisioned. An elastic adhesive may be considered such if it has an elongation at break of 150% or more, and a tensile strength of 9 MPa or less. A structural adhesive may be considered such if it has an elongation at break of less than 150%, and a tensile strength of over 9 MPa. However, adhesives are also envisioned having an elongation at break 150% or more and a tensile strength of over 9 MPa and also adhesives having an elongation at break of less than150% and a tensile strength of 9 MPa or less.

Acrylic or acrylic hybrid polymers may be utilized to form the adhesive due to the capability for rapid chain polymerization at room temperature, wide ranging mechanical properties from stiff to highly flexible, excellent adhesion to a wide range of substrates and robust durability behavior. The adhesive may likely include epoxy materials and/or polyurethane materials. Epoxy and urethane materials may be blended or pre-reacted in adduct form with acrylics in various ratios. These materials may be formulated with polymerization and cross-linking schemes commensurate with typical epoxy or urethane chemistries. Such epoxy materials may be utilized with epoxy as the primary resin base or as a hybrid with an acrylic monomer. The adhesive may also include low odor and/or non-flammable polymeric materials. The adhesive may further include one or more materials for promoting adhesion and one or more materials to act as curing agents. Various polymeric materials may be included such as rubber materials, thermoplastic materials (polyethylene, polyurethane), impact modifiers, and the like. Additional materials may also be included in the adhesive including but not limited to antioxidants, stabilizers, solvents, initiators and crosslinkers. Such materials may be selected specifically for their interaction with acrylates and methacrylates.

The adhesive may include one or more acrylate monomers, which may be methacrylate monomers. The adhesive may include at least 20% acrylate monomers, at least 40% acrylate monomers, at least 50% acrylate monomers, or even at least 60% acrylate monomers by weight of the total adhesive composition. The adhesive may include less than 80% acrylate monomers, less than 60% acrylate monomers, or even less than 40% acrylate monomers. In the event that the adhesive is a structural adhesive, it may include a higher amount of acrylate monomers, such as from about 55% to about 75% by weight acrylate monomers. An elastic adhesive material may include a lower amount of acrylate monomers, such as from about 35% to about 50% by weight acrylate monomers.

The adhesive may further include one or more impact modifiers for improving the toughness of the adhesive. The impact modifiers may be present in an amount of at least 1%, at least 5%, at least 10%, at least 20% or even at least 25% by weight of the total adhesive composition. The impact modifiers may be present in an amount of less than 40%, less than 30%, less than 20%, or even less than 10% by weight of the total adhesive composition. A structural adhesive material may include from about 5% to about 20% by weight of impact modifiers. An elastic adhesive material may include from about 15% to about 30% by weight of impact modifiers.

The adhesive may also include one or more elastomers. The elastomers may be present in an amount of at least 5%, at least 10%, at least 20% or even at least 30% by weight of the adhesive composition. The elastomers may be present in an amount of less than 50%, less than 40%, less than 30% or even less than 20% by weight of the adhesive composition. A structural adhesive material may include from about 7% to about 20% by weight of one or more elastomers. An elastic adhesive material may include from about 25% to about 40% by weight of one or more elastomers. The one or more elastomers may be one or any combination of chlorosulfonated polyethylene, chlorinated polyethylene, carboxy-terminated butadiene-acrylonitrile copolymers, vinyl-terminated butadiene-acrylonitrile copolymers, styrene-butadiene-styrene copolymers, polychloroprene, or acrylonitrile-butadiene rubber.

The adhesive may further include any number of toughening agents, stabilizers, catalysts, adhesion promoters and/or fillers. Any one, or any combination of these additional materials may be present in an amount of at least 2%, at least 5%, at least 10% or even at least 15% by weight of the adhesive composition. Any one, or any combination of these additional materials may be present in an amount of less than 20%, less than 15%, or even less than 10% by weight of the adhesive composition. A structural adhesive material may include from about 5% to about 15% by weight of one or any combination of these additional materials. An elastic adhesive material may include from about 5% to about 10% by weight of one or any combination of these additional materials. A non-limiting example adhesive composition is shown below at Table 1.

TABLE 1

| Material | Mass | Wt % |
|---|---|---|
| Monomer | 475.7 | 65.8 |
| Elastomer | 70.1 | 9.7 |
| Impact Modifier | 125.8 | 17.4 |
| Urethane-containing polymer | 12.3 | 1.7 |
| Stabilizers, Initiator, Fillers | 39.0 | 5.4 |
| Total | 723.0 | 100.0 |

The impact modifier may include one or more core/shell polymers. As used herein, the term core/shell polymer describes an impact modifier wherein a substantial portion (e.g., greater than 30%, 50%, 70% or more by weight) thereof is comprised of a first polymeric material (i.e., the first or core material) that is substantially entirely encapsulated by a second polymeric material (i.e., the second or shell material). The first and second polymeric materials, as used herein, can be comprised of one, two, three or more polymers that are combined and/or reacted together (e.g., sequentially polymerized) or may be part of separate or same core/shell systems. The first polymeric material, the second polymeric material or both of the core/shell impact modifier include or are substantially entirely composed of (e.g., at least 70%, 80%, 90% or more by weight) one or more thermoplastics. Exemplary thermoplastics include, without limitation, styrenics, acrylonitriles, acrylates, acetates, polyamides, polyethylenes or the like. It may be desirable for the glass transition temperature of the first or core polymeric material to be below 23° C. while the glass temperature of the second or shell polymeric material to be above 23° C., although not required.

Examples of useful core-shell graft copolymers are those where hard containing compounds, such as styrene, acrylonitrile or methyl methacrylate, are grafted onto core made from polymers of soft or elastomeric containing compounds such as butadiene or butyl acrylate. U.S. Pat. No. 3,985,703, which is herein incorporated by reference, describes useful core-shell polymers, the cores of which are made from butyl acrylate but can be based on ethyl isobutyl, 2-ethylhexyl or other alkyl acrylates or mixtures thereof. The core polymer, may also include other copolymerizable containing compounds, such as styrene, vinyl acetate, methyl methacrylate, butadiene, isoprene, or the like. The shell portion may be polymerized from methyl methacrylate and optionally other alkyl methacrylates, such as ethyl, butyl, or mixtures thereof methacrylates. Examples of core-shell graft copolymers include, but are not limited to, “MBS” (methacrylate-butadiene-styrene) polymers, which are made by polymerizing methyl methacrylate in the presence of polybutadiene or a polybutadiene copolymer rubber. The MBS graft copolymer resin generally has a styrene butadiene rubber core and a shell of acrylic polymer or copolymer. Examples of other useful core-shell graft copolymer resins include, ABS (acrylonitrile-butadiene-styrene), MABS (methacrylate-acrylonitrile-butadiene-styrene), ASA (acrylate-styrene-acrylonitrile), all acrylics, SA EPDM (styrene-acrylonitrile grafted onto elastomeric backbones of ethylene-propylene diene monomer), MAS (methacrylic-acrylic rubber styrene), and the like and mixtures thereof.

The adhesive may also include one or more additional polymer and/or copolymer materials, such as thermoplastics, elastomers, plastomers, combinations thereof or the like. The adhesive may include polyurethanes. Polymers that might be appropriately incorporated into the adhesive include epoxies. Combinations of epoxies and polyurethanes may be utilized. Combinations of epoxies and acrylates (e.g., methacrylates) may be utilized. Silane-modified polymers may be included.

One or more additional polymeric materials may be included. Such polymeric materials may include but are not limited to halogenated polymers, polycarbonates, polyketones, urethanes, polyesters, silanes, sulfones, allyls, olefins, styrenes, acrylates, methacrylates, silicones, phenolics, rubbers, polyphenylene oxides, terphthalates, acetates (e.g., EVA), acrylates, methacrylates (e.g., ethylene methyl acrylate polymer) or mixtures thereof. Other potential polymeric materials may be or may include, without limitation, polyolefin (e.g., polyethylene, polypropylene) polystyrene, polyacrylate, poly(ethylene oxide), poly(ethyleneimine), polyester, polysiloxane, polyether, polyphosphazine, polyamide, polyimide, polyisobutylene, polyacrylonitrile, poly(vinyl chloride), poly(methyl methacrylate), poly(vinyl acetate), poly(vinylidene chloride), polytetrafluoroethylene, polyisoprene, polyacrylamide, polyacrylic acid, polymethacrylate.

The adhesive may include a curing agent (e.g., an initiator). Examples of suitable curing agents include materials selected from aliphatic or aromatic amines or their respective adducts, amidoamines, polyamides, cycloaliphatic amines, anhydrides, polycarboxylic polyesters, isocyanates, phenol-based resins (e.g., phenol or cresol novolak resins, copolymers such as those of phenol terpene, polyvinyl phenol, or bisphenol-A formaldehyde copolymers, bishydroxyphenyl alkanes or the like), or mixtures thereof. Particular preferred curing agents include modified and unmodified polyamines or polyamides such as triethylenetetramine, diethylenetriamine tetraethylenepentamine, cyanoguanidine, dicyandiamides and the like. The curing agent may be a peroxide or sulfur curing agent. An accelerator for the curing agents (e.g., a modified or unmodified urea such as methylene diphenyl bis urea, an imidazole or a combination thereof) may also be provided for preparing the adhesive.

The adhesive material may preferably cure at room temperature with no additional stimulus. The adhesive material may undergo an induction cure, a microwave cure, an ultra-violet activated cure, or a moisture cure, any of which may occur at room temperature or at an elevated temperature. The adhesive may cure via a redox reaction cure system. The adhesive material may comprise a two-component cure system wherein cure occurs upon mixing of the two-components. Typically, the adhesive material cures at temperatures in the range of about 15° C. to about 40° C.

One or more initiators may be activated to cause substantial but not complete curing prior to use of the tape so that at least an exterior surface layer of the tape remains substantially uncured and able to adhere to a surface. At least one of the one or more initiators may be activated to cause at least partial cure prior to use of the tape. At least one of the one or more initiators may be activated to cause complete curing after use of the tape. An initiator may be applied to the tape material after use of the tape to cause substantially complete curing.

During manufacture, the adhesive material may be formed in its green state by die-cutting, extrusion, injection molding, calendaring, hand shaping, or by means of gravity. One or more of these processes may be utilized to locate the adhesive onto a substrate to form a tape material.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the Detailed Description of the Invention of a range in terms of at “‘x’ parts by weight of the resulting polymeric blend composition” also contemplates a teaching of ranges of same recited amount of “x” in percent by weight of the resulting polymeric blend composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. By use of the term “may” herein, it is intended that any described attributes that “may” be included are optional.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps. All references herein to elements or metals belonging to a certain Group refer to the Periodic Table of the Elements published and copyrighted by CRC Press, Inc., 1989. Any reference to the Group or Groups shall be to the Group or Groups as reflected in this Periodic Table of the Elements using the IUPAC system for numbering groups.

It will be appreciated that concentrates or dilutions of the amounts recited herein may be employed. In general, the relative proportions of the ingredients recited will remain the same. Thus, by way of example, if the teachings call for 30 parts by weight of a Component A, and 10 parts by weight of a Component B, the skilled artisan will recognize that such teachings also constitute a teaching of the use of Component A and Component B in a relative ratio of 3:1. Teachings of concentrations in the examples may be varied within about 25% (or higher) of the stated values and similar results are expected. Moreover, such compositions of the examples may be employed successfully in the present methods.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1. A method comprising:
applying the tape material of claim 19 to a surface in a first position;
adhering the tape material on the surface by applying pressure to the tape material;
optionally repositioning the tape material into a second position;
curing the tape material at room temperature.

2. (canceled)

3. The method of claim 1, including die-cutting, extruding, injection molding, calendaring, and/or hand shaping, the tape material.

4. The method of claim 1, including forming the tape material as a composite material comprising a scrim, non-woven web, woven web, or any combination thereof.

5. (canceled)

6. The method of claim 1, wherein the tape material is activated by applying an agent on the one or more surfaces, whereby the activating includes chemical activation, rheological activation, or both.

7. The method of claim 1, wherein the tape material is activated by applying an agent directly onto the tape material, whereby the activating includes chemical activation, rheological activation, or both.

8. The method of claim 1, wherein the tape material comprises an encapsulated agent that activates curing, polymerization, or stiffening with pressure.

9. The method of claim 1, wherein the tape material cures upon exposure to a predetermined moisture level.

10. The method of claim 1, wherein the tape material is embedded with one or more conductive elements.

11. The method of claim 10, wherein activation occurs by passing current through the one or more conductive elements.

12-14 (canceled)

15. The method of claim 8, wherein upon application of the tape material to the surface, a liquid layer of adhesive forms in between the surface and an outer layer of the tape material.

16-18 (canceled)

19. A tape material comprising:
a substrate;
an adhesive impregnated within the substrate, the adhesive comprising:
i. one or more acrylates;
ii. optionally one or more impact modifiers;
iii. one or more elastomers; and
iv. one or more initiators.

20. The tape material of claim 19, wherein the impact modifier is a core shell polymer.

21. The tape material of claim 19, wherein the substrate comprises glass, carbon, thermoplastics, natural fibers, or combinations thereof.

22. The tape material of claim 21, wherein the adhesive is free of any isocyanates.

23. (canceled)

24. The tape material of claim 19, wherein at least one of the one or more initiators is encapsulated.

25-26 (canceled)

27. The tape material of claim 19, including a scrim layer.

28. The tape material of claim 27, including a scrim layer wherein at least one of the one or more initiators is impregnated within the scrim.

29. (canceled)

30. The tape material of claim 19, wherein at least one of the one or more initiators is activated to cause substantial but not complete curing prior to use of the tape so that at least an exterior surface layer of the tape remains substantially uncured and able to adhere to a surface.

31-35 (canceled)

36. The tape material of claim 19, including a high molecular weight polymer.

37. The tape material of claim 19, including a high molecular weight polymer having active acrylic bonds that co-polymerize with a monomer throughout the tape upon activation.
